(19) United States
(12) Patent Application Publication
(10) Pub. No.: US 2026/0074800 A1
(43) Pub. Date: Mar. 12, 2026

(54) SYSTEM AND METHOD FOR DETERMINING ENCRYPTION KEYS USING A PHASE-ENCODING SIGNAL

(71) Applicant: THALES, Courbevoie (FR)

(72) Inventors: Mathieu BERTRAND, TOULOUSE (FR); Mathias VAN DEN BOSSCHE, GOYRANS (FR)

(21) Appl. No.: 18/871,080

(22) PCT Filed: Jun. 1, 2023
(86) PCT No.: PCT/EP2023/064671

§ 371 Date: Dec. 2, 2024

(30) Foreign Application Priority Data
Jun. 2, 2022 (FR) 2205316

(51) Int. Cl. H04B 10/70; H04B 10/079; H04L 9/08

(52) U.S. Cl. CPC H04B 10/70; H04B 10/0795; H04L 9/0858

(57) ABSTRACT

A transmitter to transmit an encoded interferometric signal through a transmission channel is provided, including a signal-generating module to generate an intermediate quantum signal and an intermediate reference signal. The signal-generating module generates a frequency shift between the intermediate quantum signal and the intermediate reference signal. The transmitter also includes an encoding interferometric module configured to determine the encoded interferometric signal including an encoded interferometric quantum signal and an interferometric reference signal tracing a substantially similar optical path. The encoding interferometric module includes an encoding device to apply a phase modulation to only one component of the intermediate quantum signal.

### CROSS-REFERENCE TO RELATED APPLICATIONS

This application is a National Stage of International patent application PCT/EP2023/064671, filed on Jun. 1, 2023, which claims priority to foreign French patent application No. FR 2205316, filed on Jun. 2, 2022, the disclosures of which are incorporated by reference in their entireties.

### FIELD OF THE INVENTION

The present invention generally relates to the field of quantum communication, and in particular to a system and method for achieving QKD.

### BACKGROUND

QKD (acronym of quantum key distribution) is a technology allowing secret keys to be distributed between remote users in the context of high-security optical communications (it is also referred to as secret key establishment). This technology uses cryptographic protocols based on the laws of quantum mechanics. In particular, protocols based on quantum entanglement include the P&M class of protocols (P&M standing for prepare & measure).

In the field of cryptography, the remote users are conventionally named Alice (transmitting device) and Bob (receiving device). A P&M QKD protocol employing “phase encoding” comprises a transmitting step, a receiving step, and a reconciliating step.

The transmitting first step is carried out by the transmitter Alice and consists in preparing a qubit encoded in the phase of a pulsed optical signal S possessing on average less than one photon per pulse, then in transmitting this signal S via a quantum transmission channel. The transmitter Alice in particular comprises an optical interferometer composed of two asymmetric optical arms. The qubit is then a quantum signal (i.e. a single photon) modulated with a phase modulation α in one of the arms of the interferometer of the transmitter Alice.

In the second step, which is carried out by the receiver Bob, the qubit borne by the received signal is estimated. The receiver Bob also comprises an optical interferometer that is substantially identical to the interferometer of the transmitter Alice. A phase modulation β (independent of a) is then applied to the received quantum signal, in one of the arms of the interferometer of the receiver Bob.

In the reconciliating third step, the transmitter Alice and the receiver Bob communicate the phase modulations, which are identical, i.e. such that α=β, via an authenticated public channel.

In this P&M QKD protocol, which uses phase encoding, any undesirable phase fluctuation generated by either interferometer of the QKD system leads to uncertainties in the measurement probability of the single photons reception-end and therefore to errors in the measured qubits and in secret key establishment.

Possible phase fluctuations are random phase fluctuations that may be thermal or vibrational in origin, or result from any other source of noise influencing the quality of the signal propagating through each interferometer. The net result is phase variations specific to each of the optical interferometers of the system, which will never be perfectly identical.

Other possible phase fluctuations are deterministic phase fluctuations present in systems comprising a transmitter Alice and a receiver Bob that are moving relative to each other. These fluctuations induce phase variations due to the change in the transmission geometry of the signal over time, as described in the Article “Interference at the Single Photon Level Along Satellite-Ground Channels” by G. Vallone et al. 2016, Phys. Rev. Lett. 116, 253601.

To solve problems with random phase fluctuations, known QKD systems use two different solutions. The first solution consists in achieving passive stabilization of the optical interferometers, by thermally insulating them and placing them in a vibration-free environment, as described in the article “Gigahertz decoy quantum key distribution with 1 Mbit/s secure key rate” by A. R. Dixon et al. 2008, Optics Express Vol. 16, Issue 23, pp. 18790-18797. This solution, although effective in applications involving controlled environments and fiber-optic communication on the ground, is unsuitable in applications involving extreme conditions of use. Particularly, in the space-technology field, in which at least one of the remote users is a satellite, this solution involves using an automatic-control loop on board the satellite, thus increasing the cost, weight and power consumption of its payload.

The second solution consists in time multiplexing the quantum signal with a pulsed reference signal containing a high number of photons, as described in the Article “10-Mb/s Quantum Key Distribution” by Z. Yuan et al. 2018, Journal of Lightwave Technology, Volume: 36 Issue: 16. This solution leads to a reduction in the throughput of transmitted qubits and requires use of real-time compensating electronics that can be difficult to implement. In addition, the effect of attenuation of the intensity of the pulses of the reference signal, due to variations in the level of atmospheric transmission, could be interpreted as a decrease in contrast caused by phase fluctuations in the interferometers, and thus lead to erroneous correction of the phase fluctuations.

Thus, existing QKD systems are incapable of solving problems with deterministic phase fluctuations.

There is thus a need for an improved QKD system and method capable in particular of correcting for random phase fluctuations induced by the interferometers used to encode and decode phase, and of correcting for deterministic phase fluctuations present when the transmitter and receiver are moving relative to each other.

### SUMMARY OF THE INVENTION

The present invention improves the situation by providing a transmitter (Alice) configured to transmit an encoded interferometric signal S₂ through a transmission channel, the transmitter comprising a signal-generating module configured to generate an intermediate quantum signal |Ψ₁ [symbol] and an intermediate reference signal S_{c}, the signal-generating module further being configured to generate a frequency shift Δω between the intermediate quantum signal |Ψ₁ [symbol] and the intermediate reference signal S_{c}. The transmitter also comprises an encoding interferometric module configured to receive the intermediate quantum signal |Ψ₁ [symbol] and the intermediate reference signal S_{c}, and to determine the encoded interferometric signal S₂ comprising an encoded interferometric quantum signal |Ψ_{A} [symbol] and an interferometric reference signal S_{cA} on the basis of the intermediate quantum signal |Ψ₁ [symbol] and of the intermediate reference signal S_{c} tracing a substantially similar optical path, the encoding interferometric module comprising an encoding device configured to apply a phase modulation α to only one component of the intermediate quantum signal |Ψ₁ [symbol] .

In embodiments, the encoding interferometric module may take the form of an asymmetric optical interferometer comprising a first interferometer arm and a second interferometer arm, the first interferometer arm being shorter than the second interferometer arm. The encoding device may then comprise at least one frequency-splitting unit positioned on the second interferometer arm, the frequency-splitting unit being configured to decouple, in the frequency domain, the intermediate quantum signal |Ψ₁ [symbol] and the intermediate reference signal S_{c}.

Advantageously, the signal-generating module may further comprise a time-shifting unit configured to shift, in the time domain, the intermediate quantum signal |Ψ₁ [symbol] with respect to the intermediate reference signal S_{c}.

The present invention further provides a receiver (Bob) configured to receive an encoded interferometric quantum signal |Ψ_{A} [symbol] and an interferometric reference signal S_{cA} through a transmission channel, the receiver comprising a transcoding interferometric module configured to generate a transcoded interferometric quantum signal |Ψ_{B} [symbol] and a phase-modulated interferometric reference signal S_{cB} on the basis of the encoded interferometric quantum signal |Ψ_{A} [symbol] and of the interferometric reference signal S_{cA} tracing a substantially similar optical path, the transcoding interferometric module comprising a transcoding and phase-modulating device that is configured to apply a phase modulation β_{eff} to only one component of the encoded interferometric quantum signal |Ψ_{A} [symbol] and a phase modulation φₘ to only one component of the interferometric reference signal S_{cA}. The receiver also comprises a processing module configured to take at least one measurement of the transcoded interferometric quantum signal |Ψ_{B} [symbol] and at least one measurement of the phase-modulated interferometric reference signal S_{cB}, the processing module further being configured to determine the phase modulation β_{eff} on the basis of the phase modulation φₘ and of the at least one interferometric measurement of the phase-modulated interferometric reference signal S_{cB}.

In embodiments, the transcoding interferometric module may take the form of an asymmetric optical interferometer comprising a first interferometer arm and a second interferometer arm, the first interferometer arm being shorter than the second interferometer arm. The transcoding and phase-modulating device may then comprise at least one frequency-splitting unit positioned on the second interferometer arm, the frequency-splitting unit being configured to decouple, in the frequency domain, the encoded interferometric quantum signal |Ψ_{A} [symbol] and the interferometric reference signal S_{cA}.

Advantageously, the transcoding interferometric module may comprise two optical paths at the output of the interferometer, and the processing module may comprise two processing portions, each processing portion comprising one frequency-splitting unit and being configured to take one measurement among the at least one measurement of the transcoded interferometric quantum signal |Ψ_{B} [symbol] and one measurement among the at least one measurement of the phase-modulated interferometric reference signal S_{cB}, originating from the two optical paths.

The embodiments of the invention thus provide a system for establishing a quantum encryption key, which system comprises a transmitter (Alice) and a receiver (Bob).

A method for transmitting an encoded interferometric signal S₂ is further provided, which method is implemented by the transmitter (Alice) and comprises the steps of:
generating an intermediate quantum signal |Ψ₁ [symbol] of frequency ω_{q} and an intermediate reference signal S_{c} of frequency ω_{c} having a frequency shift equal to

$${ω}_{q} - {ω}_{c}$$

applying a phase modulation α to only one component of the intermediate quantum signal |Ψ₁ [symbol] passing through an interferometer, the intermediate quantum signal |Ψ₁ [symbol] and the intermediate reference signal S_{c} tracing a substantially similar optical path so as to generate an encoded interferometric signal S₂ comprising an encoded interferometric quantum signal |Ψ_{A} [symbol] and an interferometric reference signal S_{cA},
generating an encoded interferometric signal S₂ comprising the encoded interferometric quantum signal |Ψ_{A} [symbol] and the interferometric reference signal S_{cA}.

The transmitting method further comprises a step of applying a time delay between the intermediate quantum signal |Ψ₁ [symbol] and the intermediate reference signal S_{c}.

Also provided is a method for receiving an encoded interferometric quantum signal |Ψ_{A} [symbol] and an interferometric reference signal S_{cA}, implemented by the receiver (Bob), the method comprising the steps of:
applying a phase modulation φₘ to the component of the interferometric reference signal S_{cA} and generating a phase-modulated interferometric reference signal S_{cB},
taking at least one measurement of the phase-modulated interferometric reference signal S_{cB},
determining a phase modulation β_{eff} on the basis of the phase modulation φₘ and of the measurement of the phase-modulated interferometric reference signal S_{cB},
applying the phase modulation β_{eff} to the component of the encoded interferometric quantum signal |Ψ_{A} [symbol] and generating a transcoded interferometric quantum signal |Ψ_{B} [symbol] , the encoded interferometric quantum signal |Ψ_{A} [symbol] and the interferometric reference signal S_{cA} tracing a substantially similar optical path,
taking at least one measurement of the transcoded interferometric quantum signal |Ψ_{B} [symbol] .

The system and method for establishing quantum encryption keys according to the embodiments of the invention make it possible to correct for random phase fluctuations induced by the interferometers used to encode and decode phase and to correct for deterministic phase fluctuations present when the transmitter and receiver are moving relative to each other, in order to establish the quantum key.

### BRIEF DESCRIPTION OF THE DRAWINGS

Other features, details and advantages of the invention will become apparent on reading the description provided with reference to the appended drawings, which are given by way of example.

FIG. 1 is a diagram showing a system for establishing quantum encryption keys, according to embodiments of the invention.

FIG. 2 is a diagram showing a signal-generating module of a transmitter according to embodiments of the invention.

FIG. 3 is a diagram showing an encoding interferometric module of a transmitter, according to embodiments of the invention.

FIG. 4 is a diagram showing a transcoding interferometric module of a receiver, according to embodiments of the invention.

FIG. 5 is a diagram showing a processing module of a receiver, according to embodiments of the invention.

FIG. 6 is a diagram showing a correcting unit of the processing module of a receiver, according to embodiments of the invention.

FIG. 7 is a flowchart showing a method for establishing quantum encryption keys implemented by a transmitter, according to embodiments of the invention.

FIG. 8 is a flowchart showing a method for establishing quantum encryption keys implemented by a receiver, according to embodiments of the invention.

Identical references have been used in the figures to denote identical or similar elements. For the sake of clarity, the elements shown are not to scale.

### DETAILED DESCRIPTION

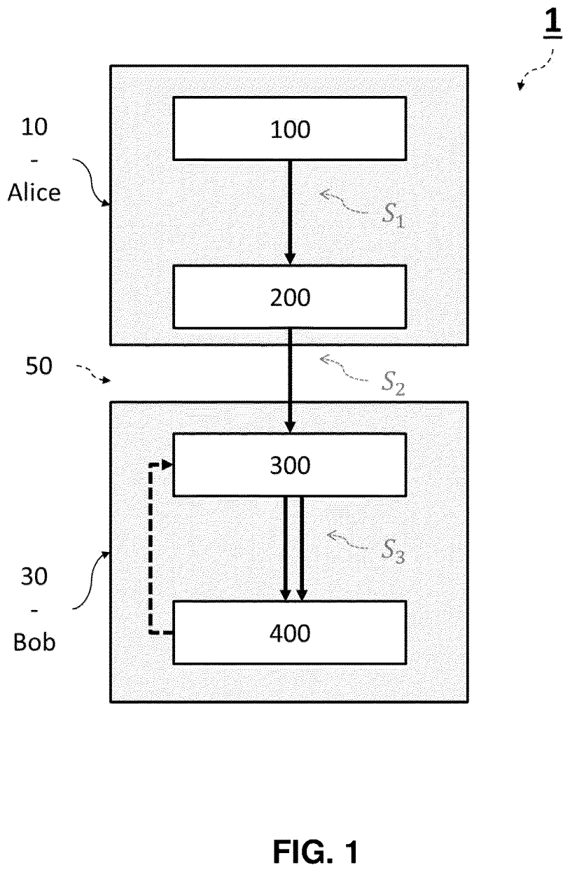

FIG. 1 schematically shows a system for establishing quantum encryption keys 1 comprising two devices 10 and 30 communicating with each other. Both devices comprise a transmitter 10, also called ‘Alice’, and a receiver 30, also called ‘Bob’.

The system 1 for establishing quantum encryption keys may for example be used, in the space-technology field, when the transmitter Alice (or vice versa the receiver Bob) is installed on board a satellite and the receiver Bob (or vice versa the transmitter Alice) is a terrestrial module. The system 1 for establishing quantum encryption keys may further be used in an application of the invention in which one or both of the devices Alice and Bob are avionic modules. In embodiments, the system 1 for establishing quantum encryption keys may also be used in an application of the invention in which one or both of the devices Alice and Bob are fiber-optic modules integrated in ground networks.

A device Alice and/or Bob may be stationary or moving relative to the other communicating device.

The transmitter Alice comprises a signal-generating module 100 and an encoding interferometric module 200. The receiver Bob comprises a transcoding interferometric module 300 and a processing module 400. Advantageously, the transmitter Alice and the receiver Bob are so-called all-fiber devices.

As used here, a ‘signal’ or ‘optical signal’ refers to a coherent light pulse, for example one obtained from a laser beam. A laser beam may in particular be characterized by its pulse rate f and by a laser pulse (i.e. the signal) defined by its intensity I, its phase and its frequency ω. The ‘frequency ω’ of the laser beam designates the ‘optical frequency of the laser pulse multiplied by 2π’ and is defined as a function of the wavelength of the beam λ, such that

$$λ \times \frac{ω}{2 π} = c ,$$

c designating the speed of light.

A ‘quantum signal’ refers to an optical signal containing on average less than one photon per pulse. Measurement of a quantum signal delivers a photon detection measurement dependent on a “probability of detection” of this photon.

As used here, ‘encoding’ refers to one or more operations consisting in generating a representation of information according to a certain code. For example, and non-limitingly, one type of encoding may comprise applying a first phase modulation to a quantum signal.

The term ‘transcoding’ refers to one or more operations consisting in converting a representation of information according to a certain code into another representation according to another, different code. For example and non-limitingly, one type of transcoding may comprise applying a second phase modulation to a phase-modulated quantum signal.

The transmitter Alice is configured to generate and transmit, through a transmission channel 50 (also called a ‘quantum channel’), an encoded signal.

The transmission channel 50 may for example be free space or a fiber-optic device for transporting information, depending on the application of the invention. The transmission channel 50 may be being watched by a spy device, called ‘Eve’ (not shown in the figures), configured to intercept the signal transmitted by the transmitter Alice.

The encoding interferometric module 200 of the transmitter Alice and the transcoding interferometric module 300 of the receiver Bob may have substantially identical architectures. An interferometric module comprises an interferometer, the interferometer comprising a first interferometer arm and a second interferometer arm.

In embodiments, the first interferometer arm of the encoding interferometric module 200 and the first interferometer arm of the transcoding interferometric module 300 do not comprise any optical elements capable of modifying the phase of a signal passing through them. Furthermore, the first interferometer arm of the encoding interferometric module 200 and the first interferometer arm of the transcoding interferometric module 300 may not induce any phase fluctuations such as to phase shift a signal passing through them, and are termed “reference arms”. In these embodiments, the second interferometer arm of the encoding interferometric module 200 and the second interferometer arm of the transcoding interferometric module 300 each comprise one or more optical elements and may be configured to modify the phase of one or more signals passing through them. Furthermore, the second interferometer arm of the encoding interferometric module 200 may comprise phase fluctuations inducing a phase shift, denoted PA, in any signal passing through it. Moreover, the second interferometer arm of the transcoding interferometric module 300 may comprise phase fluctuations inducing a phase shift, denoted PB, in any signal passing through it.

The receiver Bob is configured to receive, via the transmission channel 50, the encoded signal, i.e. the signal transmitted by the transmitter Alice, and to estimate the received signal (this resulting in an estimated received signal). The receiver Bob is further configured to determine and perform a differential correction of phase fluctuations between the phase shifts PA and PB induced in the encoded signal and in the received signal estimated by interferometric modules comprised in the system 1 for establishing quantum encryption keys, respectively.

Moreover, the transmitter Alice and the receiver Bob are configured to establish (i.e. determine) a quantum encryption key, using the encoded signal and the estimated received signal.

The signal-generating module 100 of the transmitter Alice is configured to generate, from an initial signal denoted S₀ of frequency ω₀ and of intensity I₀, an intermediate signal denoted S₁ comprising:
an intermediate quantum signal denoted S_{q} (or using quantum-state notation |Ψ₁ [symbol] ) of frequency ω_{q} and of intensity I_{q}, and
an intermediate reference signal denoted S_{c} of frequency ω_{c} and of intensity I_{c}.

In particular, the signal-generating module 100 of the transmitter Alice is configured to produce a frequency shift denoted Δω between the intermediate quantum signal |Ψ₁ [symbol] and the intermediate reference signal S_{c}, the frequency shift Δω being able to be defined by the following equation, equation (01):

$$Δ ω = {ω}_{q} - {ω}_{c} \qquad ( 01 )$$

The encoding interferometric module 200 of the transmitter Alice is configured to generate, from the intermediate signal S₁, an encoded interferometric signal denoted S₂ comprising:
an encoded interferometric quantum signal denoted |Ψ_{A} [symbol] , and
an interferometric reference signal denoted S_{cA}.

In particular, the encoding interferometric module 200 of the transmitter Alice may comprise a frequency-splitting unit positioned on the second interferometer arm of the encoding interferometric module 200. A component of the intermediate quantum signal |Ψ₁ [symbol] and a component of the intermediate reference signal S_{c} pass through the second interferometer arm of the encoding interferometric module 200. The frequency-splitting unit of the encoding interferometric module is then configured to split (i.e. select in the frequency domain) the component of the intermediate quantum signal |Ψ₁ [symbol] from the component of the intermediate reference signal S_{c} by means of the frequency shift Δω. The encoding interferometric module 200 is then configured to apply a phase modulation α, allowing a quantum encryption key to be encoded, to the component of the intermediate quantum signal |Ψ₁ [symbol] passing through the second interferometer arm of the encoding interferometric module 200.

The transcoding interferometric module 300 of the receiver Bob is configured to generate, from the encoded interferometric signal S₂, a transcoded interferometric signal S₃ comprising:
a transcoded interferometric quantum signal denoted |Ψ_{B} [symbol] , and
a phase-modulated interferometric reference signal denoted S_{cB}.

Those skilled in the art will understand that the transcoding interferometric module 300 of the receiver Bob is configured to:
project the encoded interferometric quantum signal |Ψ_{A} [symbol] onto a transcoded interferometric quantum state denoted |Ψ_{B+} [symbol] on a “first output port” of the interferometer of the module 300, and onto the transcoded interferometric quantum state denoted |Ψ_{B-} [symbol] on a “second output port” of the interferometer of the module 300, and
to generate a phase-modulated interferometric reference signal denoted S_{cB}.

In particular, the transcoding interferometric module 300 of the receiver Bob may comprise a frequency-splitting unit positioned on the second interferometer arm of the transcoding interferometric module 300. A component of the encoded interferometric quantum signal |Ψ_{A} [symbol] and a component of the interferometric reference signal S_{cA} pass through the second interferometer arm of the transcoding interferometric module 300. The frequency-splitting unit of the transcoding interferometric module is then configured to split (i.e. select in the frequency domain) the component of the encoded interferometric quantum signal |Ψ_{A} [symbol] from the component of the intermediate reference signal S_{cA}. The transcoding interferometric module 300 is then configured to apply a phase modulation β_{eff}, allowing the quantum encryption key to be transcoded, and a phase modulation φₘ, to the component of the encoded interferometric quantum signal |Ψ_{A} [symbol] and to the component of the interferometric reference signal S_{cA} passing through the second interferometer arm of the transcoding interferometric module 300, respectively.

The processing module 400 of the receiver Bob is configured to:
measure the phase-modulated reference signal S_{cB} delivered by the transcoding interferometric module 300,
determine a differential correction ε of phase fluctuations between the phase shifts φ_{A} and φ_{B} (or discrete error signal ε) on the basis of the measurement of the phase-modulated reference signal S_{cB} and of the phase modulation φₘ,
determine the one or more phase-modulation values β_{eff} on the basis of the differential correction ε and of a phase modulation, and transmit the one or more phase-modulation values β_{eff} to the transcoding interferometric module 300, and
estimate the transcoded interferometric quantum signal |Ψ_{B} [symbol] , (i.e., estimate the projection of the encoded interferometric quantum signal |Ψ_{A} [symbol] onto the transcoded interferometric quantum states |Ψ_{B+} [symbol] and |Ψ_{B-} [symbol] ).

It will be noted that, in these embodiments, the interferometric reference signal S_{cA} is not modulated by the encoding interferometric module 200 of the transmitter Alice while a component of the interferometric reference signal S_{cB} is phase modulated in the transcoding interferometric module 300 of the receiver Bob. This configuration makes it possible for the processing module 400 to determine the differential correction of phase fluctuations between the phase shifts φ_{A} and φ_{B} of the interferometric modules of the transmitter Alice and receiver Bob, without compromising the security of the secret key established (i.e. without modifying the phase modulation α), and thus to deduce the phase modulation β_{eff} via fast electronic feedback.

Similarly, a component of each of the interferometric quantum signals |Ψ_{A} [symbol] and |Ψ_{B} [symbol] , is phase modulated in one of the two interferometer arms of the encoding interferometric module 200, and in one of the two interferometer arms of the transcoding interferometric module 300, respectively. This double modulation α and β allows the transmitter Alice and the receiver Bob to produce the information required to establish a secure encryption key.

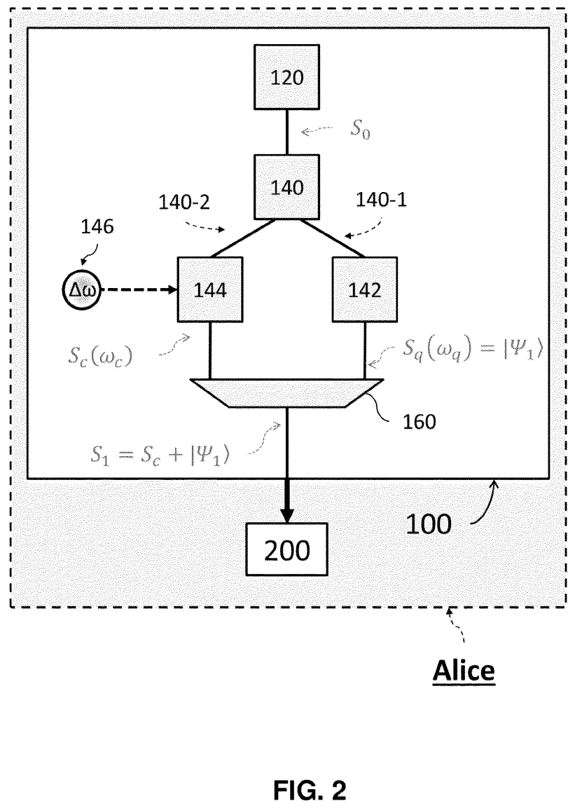

FIG. 2 schematically shows the signal-generating module 100 of the transmitter Alice, according to embodiments of the invention.

The signal-generating module 100 comprises a laser unit 120, a beam-splitting unit 140, and a beam-recombining unit 160.

In embodiments, the laser unit 120 may comprise a transmission laser emitting a laser beam having a frequency ω₀ (equivalent to a wavelength λ₀) and characterized by a coherence length denoted L_{c}.

The emission wavelength λ₀ of the laser may be located in the visible or infrared. For example and non-limitingly, the laser unit 120 may comprise a DFB laser diode (DFB being the acronym of distributed feedback) using a Bragg grating allowing the emission wavelength λ₀ to be chosen. The chosen emission wavelength λ₀ of the laser diode may be equal to 1550 nm. Such a laser diode in particular emits a continuous-wave laser beam. Alternatively, the laser unit 120 may comprise a pulsed laser source.

Thus, in embodiments, the laser unit 120 may further comprise an intensity-modulating unit (not shown in the figures) making it possible to generate, from a continuous-wave (or pulsed) laser beam, laser pulses with a pulse rate f₀ and pulse intensity I₀, and a pulse duration τ₀ of up to a few nanoseconds. The rate f₀ of the pulse train may be of the order of a few kilohertz to a few tens of gigahertz.

The laser beam may be polarized with any suitable polarization. For example, the laser beam may be linearly polarized.

Therefore, the laser unit 120 may be configured to generate an initial signal S₀ able to be defined by the following equation, equation (02):

$${S}_{0} = {0}_{} \times {e}^{i {ω}_{0} t} , such that {I}_{0} ∝ {0}_{2}^{} \qquad ( 02 )$$

The beam-splitting unit 140 is configured to split the laser beam transmitted by the laser unit 120 into two components of the initial signal (for example denoted S₀₋₁ and S₀₋₂) tracing two separate optical paths 140-1 and 140-2.

In embodiments, the beam-splitting unit 140 may be a polarization-maintaining optical coupler (for example a fiber-optic Y-coupler) that is typically placed at the output of the laser unit 120. The beam-splitting unit 140 may further be asymmetric, so as to deliver a component of the initial signal (for example S₀₋₁) composed of low-intensity pulses to optical path 140-1 and a component of the initial signal (for example S₀₋₂) composed of high-intensity pulses to optical path 140-2. Advantageously, the coupler is a 90/10 coupler, i.e. one that delivers 90% of the optical power to component S₀₋₂ of the initial signal tracing optical path 140-2 and 10% of the optical power to component S₀₋₁ of the initial signal tracing optical path 140-1. The beam-splitting unit 140 may thus generate both signal components S₀₋₁ and S₀₋₂. The signal components S₀₋₁ and S₀₋₂ may be defined by the following equations, equations (03) and (04):

$${S}_{0 - 1} = \sqrt{t} \times {S}_{0} , such that t = 90 \% for example , and \qquad ( 03 )$$

$${S}_{0 - 2} = \sqrt{1 - t} \times {S}_{0} \qquad ( 04 )$$

The signal-generating module 100 further comprises a unit 142 configured to generate a ‘quantum signal’ from the component S₀₋₁ of the initial signal tracing optical path 140-1.

In embodiments of the invention, the unit 142 for generating a quantum signal may be an optical attenuator making it possible to form the quantum signal having an amplitude I_{q} equivalent on average to less than one photon per pulse. The unit 142 for generating a quantum signal is thus configured to generate the quantum signal S_{q}(I_{q}, ω₀) called the intermediate quantum signal, which is also designated |Ψ₁ [symbol] in quantum-state notation.

Moreover, the unit 142 for generating a quantum signal may comprise another intensity-modulating unit (not shown in the figures) configured to perform an additional pulse modulation on the quantum signal and/or on the component S₀₋₁ of the initial signal tracing optical path 140-1. For example, such a unit may be used to implement a protocol applying quantum decoy states.

In embodiments, in particular if the laser unit 120 comprises a continuous-wave laser source, the unit 142 for generating a quantum signal may also comprise a phase-modifying unit (not shown in the figures) configured to modify the phase of each of the quantum pulses tracing optical path 140-1. Advantageously, the phase-modifying unit may be configured to randomize (i.e. make random) the phase of each of these quantum pulses, so that the phases of two consecutive quantum pulses are independent of each other. It will be noted that phase randomization may make it possible to prevent certain types of quantum-key attack able to be carried out by a spy device, called ‘Eve’, placed on the transmission channel 50, the spy device intercepting the reference signal transmitted by the transmitter Alice and taking advantage of the phase coherence between pulses. Such a phase-modifying unit may for example be a phase modulator.

The signal-generating module 100 further comprises a unit 144 configured to generate a ‘reference signal’ from the component S₀₋₂ of the initial signal tracing optical path 140-2.

In embodiments of the invention, the unit 144 for generating a reference signal may be a frequency-shifting unit configured to form a reference signal having a frequency ω_{c} shifted with respect to the frequency ω₀ of the initial signal and of the component S₀₋₂ of the initial signal tracing optical path 140-2, by a shift Δω=ω₀−ω_{c}. The unit 144 for generating a reference signal then generates a signal S_{c}(I_{c}, ω_{c}), called the intermediate reference signal, which is able to be defined by the following equation, equation (05):

$${S}_{c} ( {ω}_{c} ) = {c}_{} \times {e}^{i ( {ω}_{s} - Δ ω ) t} = {c}_{} \times {e}^{i {ω}_{c} t} , such that {c}_{} = \sqrt{t} \times {0}_{} \qquad ( 05 )$$

The unit 144 for generating a reference signal may for example be an acousto-optic modulator (AOM) or an acousto-optic frequency shifter (AOFS) or a phase modulator. The signal-generating module 100 may thus comprise, for example and non-limitingly, a voltage generator 146 allowing the shift Δω to be controlled. It will be noted that the shift Δω to be applied is chosen so as to obtain spectral decoupling between the intermediate reference signal S_{c} and the |Ψ₁ [symbol] corresponding intermediate quantum signal, in order to prevent the spy device ‘Eve’ placed on the transmission channel 50 and intercepting the reference signal transmitted by the transmitter Alice from being able to deduce therefrom the phase fluctuations to be corrected and thus the qubits transmitted. According to one non-limiting example, for a chosen emission wavelength, equal to 1550 nm, a shift Δω between 1 GHz and 130 GHz may allow a variation from a few picometres to 1 nm between the wavelength of the intermediate reference signal S_{c} and the wavelength of the intermediate quantum signal |Ψ₁ [symbol] .

In certain embodiments, the unit 144 for generating a reference signal (or the unit 142 for generating a quantum signal) may further comprise a time-shifting unit (not shown in the figures) configured to time shift the beam components with respect to each other. The component tracing optical path 140-1 (i.e. the quantum signal |Ψ₁ [symbol] ) may be delayed by a time Δt with respect to the beam component tracing optical path 140-2 (i.e. the reference signal S_{c}). This time Δt may for example be defined as a function of the pulse rate fₛ of the beam and/or the pulse duration τₛ, such that

$$\frac{1}{{f}_{s}} > Δ τ > {τ}_{s} .$$

This time Δτ may also be defined as a function of the implementation time τᵣ of the electronic feedback, so as to be able to deduce within the receiver Bob the phase modulation β_{eff} and correct the phase fluctuations, such that Δt<τᵣ.

The beam-recombining unit 160, at the end of the two separate optical paths 140-1 and 140-2, allows the two signal components to be recombined on a single optical path into an intermediate signal S₁ transmitted to the encoding interferometric module 200 and able to be defined by the following equation, equation (06):

$${S}_{1} = {S}_{c} + \vert {Ψ}_{1} 〉 \qquad ( 06 )$$

The frequency-recombining unit 160 for recombining the quantum signal with the reference signal may for example be, depending on the embodiments used, a frequency multiplexer (commonly denoted MUX) the technology of which depends on the frequency shift Δω between the intermediate reference signal S_{c} and the intermediate quantum signal |Ψ₁ [symbol] .

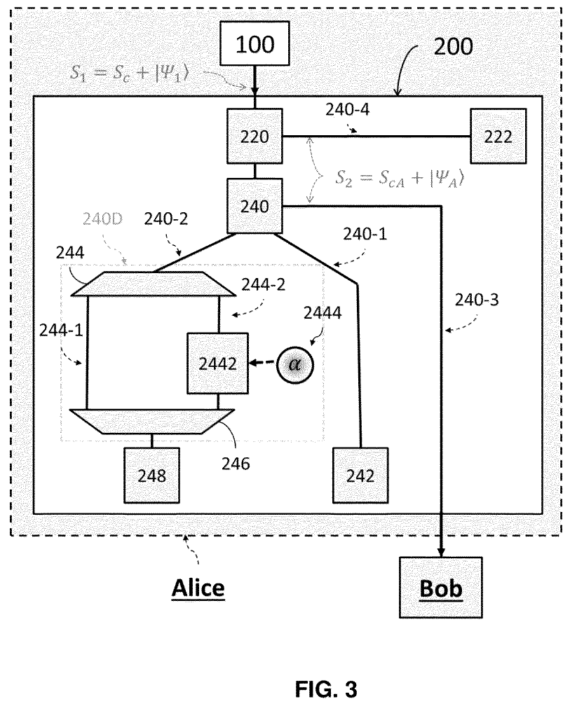

FIG. 3 schematically shows an encoding interferometric module 200 of the transmitter Alice, according to embodiments of the invention.

The encoding interferometric module 200 comprises a beam splitter 240 configured to split the transmitted intermediate signal S₁ into two beam components, for example denoted S₁₋₁ and S₁₋₂, each tracing a first interferometer arm denoted 240-1 or a second interferometer arm denoted 240-2. The intermediate signal S₁ comprises the intermediate reference signal S_{c} and the intermediate quantum signal |Ψ₁ [symbol] and each of the components S₁₋₁ and S₁₋₂ of the intermediate signal comprises one component of the intermediate reference signal S_{c} (for example S_{c-1} or S_{c-2}) and one quantum state (or more simply ‘component’) of the intermediate quantum signal |Ψ₁ [symbol] (for example |Ψ₁₋₁ [symbol] or |Ψ₁₋₂ [symbol] . The beam-splitting unit 240 may be a polarization-maintaining symmetric optical coupler (for example a 50/50 Y-coupler) configured to deliver two components S₁₋₁ and S₁₋₂ of the intermediate signal, which components are composed of pulses of equal intensity.

According to embodiments, the encoding interferometric module 200 may be a Michelson interferometer, as in the example illustrated in FIG. 3. Advantageously, such an encoding interferometric module 200 may comprise Faraday mirrors 242 and 248, placed at the ends of interferometer arms 240-1 and 240-2, and configured to compensate for certain polarization variations experienced by the components S₁₋₁ and S₁₋₂ of the intermediate signal during their respective trip along one of the two interferometer arms 240-1 or 240-2.

Moreover, as shown in FIG. 3, in these embodiments, the beam splitter 240 of the encoding interferometric module 200 may be configured to recombine, into a resulting encoded interferometric signal S₂, the beam components S₁₋₁ and S₁₋₂ of the intermediate signal, following their respective trip along one of the two interferometer arms 240-1 or 240-2.

Alternatively, the encoding interferometric module 200 may be a Mach-Zehnder interferometer (configuration not shown in the figures). In these embodiments, the encoding interferometric module 200 comprises a beam coupler placed at the end of the interferometer arms 240-1 and 240-2 and configured to recombine the beam components S₁₋₁ and S₁₋₂ of the intermediate signal, into a resultant interferometric signal S₂.

The first interferometer arm 240-1 does not comprise any additional optical elements. Furthermore, the first interferometer arm 240-1 is the phase reference arm, such that the component S₁₋₁ of the intermediate signal tracing the first interferometer arm 240-1 does not undergo any phase fluctuations.

In embodiments, the two interferometer arms 240-1 and 240-2 may have different arm lengths, such that the interferometer comprises a short interferometer arm and a long interferometer arm. The length difference between the two interferometer arms is denoted ΔL. The interferometer of the encoding module 200 and the interferometer of the transcoding module 300 (since they have substantially identical architectures) are able to have the same length difference ΔL. For example, and non-limitingly, this length difference ΔL may be less than the coherence length L_{c} of the laser unit 120, and greater than the pulse size L₀, which is defined based on the duration of a pulse L₀=c×τ₀,c designating the speed of light and τ₀ the pulse duration. This length difference ΔL induces a temporal separation between the components S₁₋₁ and S₁₋₂ of the intermediate signal, each tracing one of the two interferometer arms 240-1 or 240-2, after recombination into an encoded interferometric signal S₂. Generally, for an interferometer, this temporal separation is defined such that the signal components are delayed by a time Δt, calculated based on the difference ΔL. Furthermore, one component output from an interferometer is delayed by a delay called the “interferometric delay” and denoted t, such that:
a component tracing the short interferometer arm is delayed by an interferometric delay t=0; and
the component tracing the long interferometer arm is delayed by an interferometric delay t=Δt with respect to the component tracing the short interferometer arm.

In a first variant of the invention, the first interferometer arm 240-1 may be the short interferometer arm. In this variant of the invention, the second interferometer arm 240-2 may be the long interferometer arm, depending on the length difference ΔL between the two arms. Alternatively, in a second variant of the invention, the first interferometer arm 240-1 may be the long interferometer arm, while the second interferometer arm 240-2 may be the short interferometer arm.

The encoding interferometric module 200 further comprises an encoding device 240D configured to apply a phase modulation α to only one component of the intermediate quantum signal |Ψ₁ [symbol] . In particular, the encoding device 240D may be placed (i.e. positioned) on the second interferometer arm 240-2.

The encoding device 240D may comprise a frequency-splitting unit 244 configured to split (i.e. select in the frequency or spectral domain) the component S₁₋₂ of the intermediate signal tracing the second interferometer arm 240-2, so as to obtain the following beam components:
the component S_{c-2} of the intermediate reference signal S_{c}, which traces a path called the “reference-signal path of the transmitter Alice” 244-1, and
the quantum state |Ψ₁₋₂ [symbol] corresponding to the photon of the intermediate quantum signal, which traces a path called the “quantum-signal path of the transmitter Alice” 244-2.

Moreover, the encoding device 240D may comprise a frequency-recombining unit 246 configured to recombine, in the frequency domain, on the second interferometer arm 240-2, the components S_{c-2} and |Ψ₁₋₂ [symbol] tracing the signal paths 244-1 and 244-2.

The frequency-recombining unit 246 may be identical to the frequency-splitting unit 244 of the signal-generating module 100. For example, these two units may be frequency demultiplexers (denoted DEMUX) based on a technology that depends on the frequency shift Δω between the intermediate reference signal S_{c} and the intermediate quantum signal S_{q}.

As shown in FIG. 3, the reference signal path 244-1 of the transmitter Alice does not comprise any additional optical elements.

Advantageously, the encoding device 240D may comprise a phase-modulating unit 2442 configured to modulate, according to a parameter α (also called the ‘phase modulation α’), the phase of the photon (quantum state |Ψ₁₋₂ [symbol] ) of the intermediate quantum signal tracing the quantum-signal path 244-2 of the transmitter Alice. The phase-modulating unit 2442 may also be called the ‘encoding unit’ 2442 (as it allows a quantum encryption key to be encoded).

For example and non-limitingly, an encoding unit 2442 may be an electro-optical modulator made up of electro-optical crystals to which an electrical signal defined using a control unit 2444 is applied. The control unit may for example be a voltage generator configured to control the parameter. The phase of the photon (quantum state |Ψ₁₋₂ [symbol] ) of the intermediate quantum signal passing through the unit 2442 is then modulated so as to encode a qubit.

Advantageously, the parameter α may be chosen from a set of two orthogonal bases such as for example [0, π] and [π/2, 3π/2]. It will be noted that this choice of parameter α and phase encoding of the qubit is a novel alternative to the conventional approach of a protocol called BB84 (as described in the article “Quantum cryptography: Public key distribution and coin tossing” by C. Bennett and G. Brassard, 1884, theoretical computer Science, vol. 560, 1984, p. 7-11). In the BB84 protocol, the qubit is encoded in the polarization of the photons (and not in their phase). Conventional implementation of the BB84 protocol, in which polarization is encoded, is limited by system constraints relating to the correction of errors in the polarization of the quantum signal. Since this correction is of mechanical type (it for example uses motorized half-wave plates), conventional implementation of the BB84 protocol is therefore limited in terms of the bandwidth of the quantum signal, with respect to a phase-encoding solution using electro-optical devices (for example an electro-optical modulator) allowing a high throughput to be achieved. The high throughput obtained with the embodiments of the invention is also greater than the throughput obtained with encoding based on time-division multiplexing, which requires more corrections of fluctuation-induced errors and thus requires the throughput with which qubits are encoded and transferred to be decreased. In an application of the invention to the space-technology field, the number of qubits encoded and transferred is for example limited by the pass time of a satellite. The number of qubits exchanged during a pass is therefore decreased in this case. Moreover, if fluctuations become too great, the critical correctable-error threshold (equal to about 10%) may be exceeded, establishment of the key then becoming impossible. The high throughput of the phase-encoding method thus has the advantage of increasing the number of qubits exchanged in a time-limited quantum communication, this making it possible to establish a secret key between two remote users.

The control unit 2444 of the encoding unit 2442 of the transmitter Alice may advantageously comprise a quantum random number generator, which is more secure than the software-based pseudo-random number generators conventionally used in computers to generate random numbers. Such conventional pseudo-random number generators use a deterministic algorithm to produce predicted random-number sequences. In contrast, a quantum random number generator makes it possible to obtain a sequence of parameters α to be encoded in the phase of the quantum signal, randomly according to a quantum statistical probability that is not predictable, this allowing a more secure secret key to be provided.

Moreover, the components |Ψ₁₋₂ [symbol] of the intermediate quantum signal and S_{c-2} of the intermediate reference signal tracing the second interferometer arm 240-2 may undergo phase fluctuations. However, these two components |Ψ₁₋₂ [symbol] and S_{c-2} follow similar optical paths and hence, on exiting the interferometer of the encoding interferometric module 200, the components |Ψ₁₋₂ [symbol] and S_{c-2} have the same phase shift φ_{A} with respect to the components |Ψ₁₋₁ [symbol] and S_{c-1} tracing the first interferometer arm 240-1. This is not the case in prior-art devices in which the quantum signal and the reference signal follow different optical paths, for example if the reference signal takes a short first interferometer arm and the quantum signal “takes” a long second interferometer arm. It will be noted that the term “take” in the case of the quantum signal is used for the sake of simplicity. Specifically, in practice, the quantum signal does not “take” one specific optical path or the other but more precisely the equivalent of a superposition of the two optical paths.

On exiting the interferometer of the encoding interferometric module 200, the resulting interferometric reference signal, denoted S_{cA}, may be defined as a function of the intermediate reference signal S_{c} and of the phase shift φ_{A}, by the following equation, equation (07):

$${S}_{cA} = \frac{1}{2} \times ( 1 + {e}^{i {φ}_{A}} ) \times {S}_{c} \qquad ( 07 )$$

In particular, the interferometric reference signal S_{cA} is made up of two conventional light pulses of the same intensity, separated in time by the quantity Δt, which is defined based on the difference ΔL.

On exiting the interferometer of the encoding interferometric module 200, the resulting encoded interferometric quantum signal, denoted |Ψ_{A} [symbol] , may be defined as a function of the phase modulation α and of the phase shift φ_{A}, by the following equation, equation (08):

$$\vert {Ψ}_{A} 〉 = \frac{1}{\sqrt{2}} \times ( \vert {Ψ}_{1 - 1} 〉 + {e}^{i ( α + {φ}_{A} )} \vert {Ψ}_{1 - 2} 〉 ) \qquad ( 08 )$$

It will be noted that the quantum state |Ψ_{A} [symbol] may be represented by a superposition of the states |Ψ₁₋₁ [symbol] and |Ψ₁₋₂ [symbol] , such that the state |Ψ₁₋₁ [symbol] corresponds to the photon of the intermediate quantum signal having taken the first interferometer arm 240-1 and the state |Ψ₁₋₂ [symbol] corresponds to the photon of the intermediate quantum signal having taken the second interferometer arm 240-2.

Therefore, on exiting the interferometer of the encoding interferometric module 200, the encoded interferometric signal S₂ comprises the interferometric reference signal S_{cA} and the encoded interferometric quantum signal |Ψ_{A} [symbol] , and may be defined by the following equation, equation (09):

$${S}_{2} = {S}_{cA} + \vert {Ψ}_{A} 〉 \qquad ( 09 )$$

As shown in FIG. 3, in embodiments using a Michelson interferometer, the encoded interferometric signal S₂ may then propagate on the one hand toward the signal-generating module 100 and on the other hand toward the receiver Bob, via the optical path 240-3. In these embodiments, the encoding interferometric module 200 of the transmitter Alice may further comprise a signal-deflecting unit 220 configured to deflect (i.e. steer) the encoded interferometric signal S₂ to a control unit 222 for controlling the interferometric signal. For example, the control unit 222 may be a control photodiode allowing the encoded interferometric signal S₂ transmitted by the transmitter Alice to the receiver Bob to be controlled. The signal-deflecting unit 320 may be an optical circulator. The signal-deflecting unit 220 makes it possible to prevent the encoded interferometric signal S₂ from being transferred to the signal-generating module 100.

During propagation through the transmission channel 50 between the transmitter Alice and the receiver Bob, the quantum signal and the reference signal of the encoded interferometric signal S₂ may also undergo propagation-related phase fluctuations. Since propagation through the transmission channel 50 is common to both components of the encoded interferometric signal S₂, these propagation-related phase fluctuations have no influence on the result of the quantum-interference measurement performed by the receiver Bob.

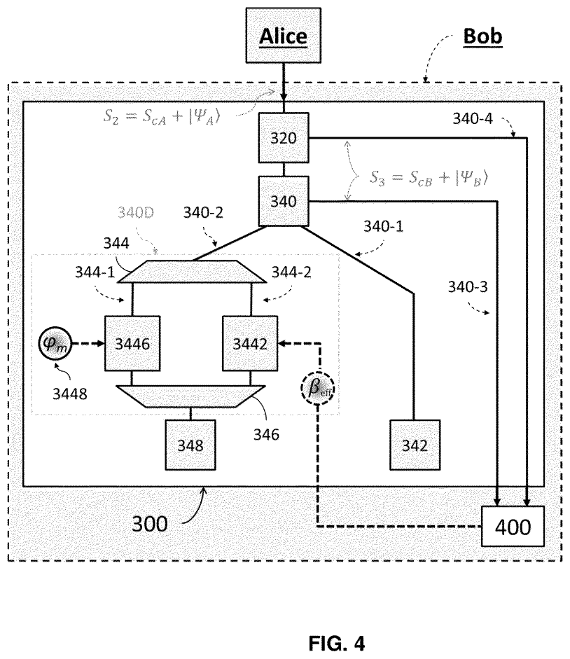

FIG. 4 schematically shows a transcoding interferometric module 300 of the receiver Bob, according to embodiments of the invention.

The transcoding interferometric module 300 has an asymmetric optical interferometer architecture similar to the encoding interferometric module 200 of the transmitter Alice. Thus, the transcoding interferometric module 300 comprises a beam splitter 340 (for example a symmetric a symmetric polarization-maintaining fiber-optic 50/50 optical Y-coupler) configured to split the beam of the interferometric signal S₂ transmitted by the transmitter Alice into two beam components, denoted S₂₋₁ and S₂₋₂. The components S₂₋₁ and S₂₋₂ (which are composed of pulses of equal intensity for example) each trace a first interferometer arm denoted 340-1 or a second interferometer arm denoted 340-2. Since the encoded intermediate signal S₂ comprises a reference signal and a quantum signal, each of the components S₂₋₁ and S₂₋₂ of the intermediate signal comprises one component of the interferometric reference signal (for example denoted S_{cA-1} or S_{cA-2}) and one quantum state (or more simply “component”) of the interferometric quantum signal (for example denoted |Ψ_{A-1} [symbol] or |Ψ_{A-2} [symbol] ).

In one embodiment in which the encoding interferometric module 200 of the transmitter Alice is a Mach-Zehnder interferometer, the transcoding interferometric module 300 may be a Mach-Zehnder interferometer. In another embodiment in which the encoding interferometric module 200 is a Michelson interferometer, the transcoding interferometric module 300 may advantageously be a Michelson interferometer comprising Faraday mirrors 342 and 348, each placed at the end of one of the two interferometer arms 340-1 and 340-2 so as to compensate for the variations in polarization undergone by the beam components S₂₋₁ and S₂₋₂.

Similarly to the encoding interferometric module 200 of the transmitter Alice, the first interferometer arm 340-1 does not comprise any additional optical elements. Furthermore, the first interferometer arm 340-1 is the phase reference arm, such that the component S₂₋₁ of the encoded interferometric signal S₂ does not undergo any phase fluctuations. The first interferometer arm 340-1 may be the shorter arm while the second interferometer arm 340-2 is the longer arm, the two arms having between them a length difference ΔL. Alternatively, the first interferometer arm 340-1 may be the longer interferometer arm, while the second interferometer arm 340-2 is the shorter interferometer arm.

The transcoding interferometric module 300 of the receiver Bob further comprises a transcoding and phase-modulating device 340D configured to apply a phase modulation β_{eff} to only one component of the encoded interferometric quantum signal |Ψ_{A} [symbol] and a phase modulation φₘ to only one component of the interferometric reference signal S_{cA}. The transcoding and phase-modulating device 340D may be placed (i.e. positioned) on the second interferometer arm 340-2.

The transcoding and phase-modulating device 340D may comprise a frequency-splitting unit 344 configured to split (i.e. select in the frequency domain) the component S₂₋₂ of the intermediate signal tracing the second interferometer arm 340-2, so as to obtain the following beam components:
the component S_{cA-2} of the interferometric reference signal S_{cA} tracing the reference-signal path 344-1 of the receiver Bob, and
the quantum state |Ψ_{A-2} [symbol] corresponding to the photon of the intermediate quantum signal tracing the quantum-signal path 244-2 of the receiver Bob.

The transcoding and phase-modulating device 340D may comprise a frequency-recombining unit 346 configured to recombine, in the frequency domain, on the second interferometer arm 340-2, the components S_{cA-2} and |Ψ_{A-2} [symbol] tracing the signal paths 344-1 and 344-2.

The frequency-splitting unit 344 and the frequency-recombining unit 346 of the receiver Bob may be identical to the frequency-splitting unit 244 and the frequency-recombining unit 246 of the transmitter Alice, respectively. They may thus take the form of a frequency demultiplexer and multiplexer based on a technology that depends on the frequency shift Δω between the intermediate reference signal S_{c} and the intermediate quantum signal S_{q}.

Unlike the encoding device 240D of the transmitter Alice, the transcoding and phase-modulating device 340D of the receiver Bob may comprise a phase-modulating unit 3446 configured to modulate, according to a parameter φₘ, the phase of the component S_{cA-2} of the interferometric reference signal S_{cA} propagating along the reference signal path 344-1 of the receiver Bob.

The phase-modulation parameter φₘ of the phase-modulating unit 3446 may be controlled by a control unit 3448, which may for example be a voltage generator configured to transmit a radio-frequency signal allowing a sinusoidal phase modulation to be generated. This radio-frequency signal may have a zero phase and depend on a frequency ωₘ. Such a phase modulation denoted φₘ may be defined, as a function of a parameter Δφ corresponding to the modulation depth, according to the following equation, equation (10):

$${φ}_{m} ( t ) = Δφ \times cos ( {ω}_{m} \cdot t ) \qquad ( 10 )$$

Similarly to the encoding device 240D of the transmitter Alice, the transcoding and phase-modulating device 340D of the receiver Bob may comprise a phase-modulating unit 3442 configured to modulate, according to a parameter β_{eff}, the phase of the photon (quantum state |Ψ_{A-2} [symbol] ) of the intermediate quantum signal tracing the quantum signal path 344-2 of the receiver Bob. For example, and non-limitingly, the phase-modulating unit 3442 may be similar to the phase-modulating unit 2442. The phase-modulating unit 3442 may also be called a transcoding unit 3442 (as it allows the encoded information of the quantum encryption key to be transcoded).

The components |Ψ_{A-2} [symbol] of the interferometric quantum signal and S_{cA-2} of the interferometric reference signal tracing the second interferometer arm 340-2 may undergo phase fluctuations. However, these two components follow similar optical paths and hence on exiting the interferometer of the transcoding interferometric module 300, the components |Ψ_{A-2} [symbol] and S_{cA-2} have the same phase shift φ_{B}.

On exiting the interferometer of the transcoding interferometric module 300, the in-phase interferometric reference signal, denoted S_{cB}, may be defined as a function of the interferometric reference signal S_{cA} and of the phase shifts φₘ and φ_{B}, by the following equation, equation (11):

$${S}_{cB} = \frac{1}{2} \times ( 1 + {e}^{i \times ( {φ}_{m} + {φ}_{B} )} ) \times {S}_{cA} \qquad ( 11 )$$

In particular, the interferometric reference signal S_{cA} consists of three conventional light pulses, separated in time by the amount Δt (i.e. pulses of interferometric delay equal to 0, Δt and 2×Δt), defined based on the length difference ΔL of interferometers of the transmitter Alice and receiver Bob.

In embodiments, the processing module 400 is configured to determine the differential correction of the phase fluctuations between the phase shifts φ_{A} and φ_{B} of the interferometric modules 200 and 300, on the basis of measurements of the predefined intensity fluctuations in the interferometric reference signal S_{cA}, at the output of the transcoding interferometric module 300. The intensity fluctuations in particular correspond to interference between the photons of the reference signal, which is made up of conventional light pulses having an interferometric delay Δt, and therefore having taken:
on the one hand, the first interferometer arm 240-1 of the transmitter Alice then the second interferometer arm 340-2 of the receiver Bob, and
on the other hand, the second interferometer arm 240-2 of the transmitter Alice then the first interferometer arm 340-1 of the receiver Bob.

According to embodiments of the invention, the phase-modulation parameter β_{eff} of the transcoding unit 3442 may be directly controlled by the processing module 400 of the receiver Bob, as shown in FIG. 4. In particular, the parameter β_{eff} may then be defined based on a phase-modulation parameter β obtained in a similar way to the parameter α, but comprising a differential correction of the phase fluctuations between the phase shifts φ_{A} and φ_{B} of the interferometric modules 200 and 300, which differential correction is defined based on at least one measurement of the interferometric reference signal S_{cB}.

To simplify matters, on exiting the interferometer of the transcoding interferometric module 300, the resulting transcoded interferometric quantum signal, denoted |Ψ_{B} [symbol] , may be defined as a function of the encoded interferometric quantum signal |Ψ_{A} [symbol] , of the phase modulation β_{eff} and of the phase shift φ_{B}.

Therefore, on exiting the interferometer of the transcoding interferometric module 300, the transcoded interferometric signal S₃ comprises the interferometric reference signal S_{cB} and the transcoded interferometric quantum signal |Ψ_{B} [symbol] , and may be defined by the following equation, equation (12):

$${S}_{3} = {S}_{cB} + \vert {Ψ}_{B} 〉 \qquad ( 12 )$$

As shown in FIG. 4, in embodiments using a Michelson interferometer, the transcoded interferometric signal S₃ may propagate on the one hand toward the transmitter Alice and on the other hand toward the processing module 400, along the optical path 340-3 (which corresponds to the first output port of the interferometer of the module 300). In such embodiments, the transcoding interferometric module 300 may further comprise a signal-deflecting unit 320 configured to deflect (i.e. steer) the transcoded interferometric signal S₃ to the processing module 400 along the optical path 340-4 (which corresponds to the second output port of the interferometer of the module 300). For example, the signal-deflecting unit 320 may be an optical circulator. The signal-deflecting unit 320 makes it possible to prevent the transcoded interferometric signal S₃ from being transferred to the transmission channel 50.

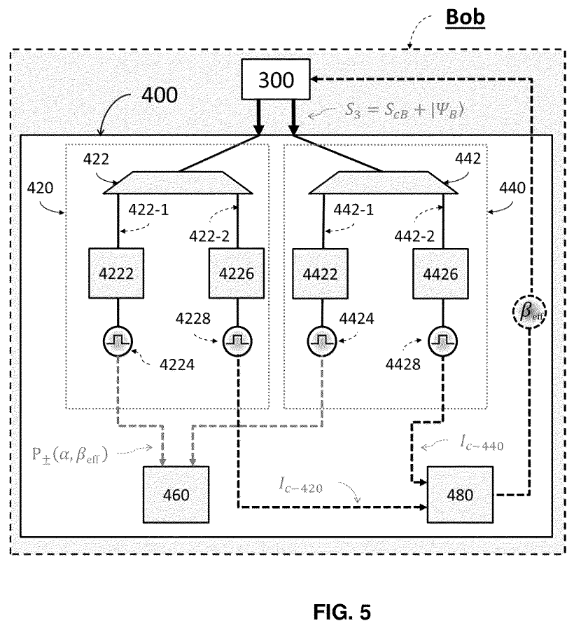

FIG. 5 schematically shows the processing module 400 of the receiver Bob, according to embodiments of the invention.

The processing module 400 comprises two processing portions, each associated with one of the two optical paths 340-3 and 340-4 obtained at the output of the interferometric module 300 of the receiver Bob.

Each processing portion 420 (440, respectively) comprises a frequency-splitting unit 422 (442, respectively) configured to split (i.e. select in the frequency domain) the phase-modulated interferometric reference signal S_{cB} from the resulting transcoded interferometric quantum signal |Ψ_{B} [symbol] so that they trace one of the two measurement arms 422-1 or 422-2 (442-1 or 442-2, respectively) associated with the processing portion 420 (440, respectively). For example and non-limitingly, the measurement arm 422-1 of processing portion 420 and the measurement arm 442-1 of processing portion 440 may be the quantum measurement arms, whereas the measurement arm 422-2 of processing portion 420 and the measurement arm 442-2 of processing portion 440 may be the reference measurement arms. Consequently, the transcoded interferometric quantum signal |Ψ_{B} [symbol] traces the quantum measurement arm 422-1 (442-1, respectively), and the phase-modulated interferometric reference signal S_{cB} traces the reference measurement arm 422-2 (442-2, respectively). The frequency-splitting units 422 and 442 may be frequency demultiplexers based on a technology that depends on the frequency shift Δω between the intermediate reference signal S_{c} and the intermediate quantum signal S_{q}.

Each processing portion 420 (440, respectively) comprises a single-photon detector 4222 (4422, respectively) positioned on the quantum measurement arm 422-1 (442-1, respectively). A single-photon detector may comprise a detection surface and be configured to detect the “presence” of single photons at its detection surface (i.e. via photon/surface interaction). This detection of the presence of single photons is defined in terms of a given quantum detection efficiency. For example and non-limitingly, the single-photon detector 4222 (4422, respectively) may be an avalanche photodiode (APD) or even a superconducting nanowire single-photon detector (SNSPD). In particular, the single-photon detector 4222 (4422, respectively) may comprise an internal amplification mechanism configured to deliver a voltage, when a photon is detected.

Each photon detector 4222 and 4422 may be configured to take a measurement called the “interferometric measurement” of the transcoded interferometric quantum signal |Ψ_{B} [symbol] . In other words, each photon detector 4222 and 4422 is able to measure the result of interference between photons on the basis of the projection of the quantum state associated with the intermediate quantum signal |Ψ_{A} [symbol] onto the quantum state associated with the transcoded interferometric quantum signal |Ψ_{B} [symbol] .

Those skilled in the art will understand that the processing module 400 is configured to select, in the time domain, the transcoded interferometric quantum signal |Ψ_{B} [symbol] , the encoded interferometric quantum signal |Ψ_{A} [symbol] then being projected:
in the receiving module 4222, onto a quantum state denoted |Ψ_{B+} [symbol] such that:

$$\vert {Ψ}_{B +} 〉 = \frac{1}{\sqrt{2}} \times ( \vert {Ψ}_{A - 1} 〉 + {e}^{i ( β + {φ}_{B} )} \vert {Ψ}_{A - 2} 〉 ) \qquad ( 13 )$$

in the receiving module 4422, onto a quantum state denoted |Ψ_{B-} [symbol] such that:

$$\vert {Ψ}_{B -} 〉 = \frac{1}{\sqrt{2}} \times ( \vert {Ψ}_{A - 1} 〉 - {e}^{i ( β + {φ}_{B} )} \vert {Ψ}_{A - 2} 〉 ) \qquad ( 14 )$$

The quantum states |Ψ_{B+} [symbol] and |Ψ_{B-} [symbol] are also called “transcoded quantum states”. As shown in equations (13) and (14), the quantum states |Ψ_{B+} [symbol] and |Ψ_{B-} [symbol] may be represented by a superposition of the states |Ψ_{A-1} [symbol] and |Ψ_{A-2} [symbol] , such that the state |Ψ_{A-1} [symbol] corresponds to the photon of the encoded interferometric quantum signal having taken the first interferometer arm 340-1 and the state |Ψ_{A-2} [symbol] corresponds to the photon of the encoded interferometric quantum signal having taken the second interferometer arm 340-2.

A “probability of detection”, denoted P₊ (or P₋), of the single-photon detector 4222 (or 4422) may be defined, by the following equation, equation (15):

$${P}_{\pm } = {\vert 〈 {Ψ}_{B \pm } \vert {Ψ}_{A} 〉 \vert}^{2} \qquad ( 15 )$$

According to equation (15), the transcoded interferometric quantum signal, resulting from the transcoding interferometric module 300, may be decomposed into a basis of four defined temporal modes such that:

the first temporal mode (corresponding to a state |Ψ_{A}-1Ψ₁₋₁ [symbol] ) corresponds to the photon having taken the first interferometer arm 240-1 of the transmitter Alice then the first interferometer arm 340-1 of the receiver Bob. In this case, the interferometric delay of the photon is zero (t=0) and the probability of detection of a photon, possessing by convention a zero phase, does not depend on the phase modulations α and β_{eff},
the second temporal mode (corresponding to a state |Ψ_{A-2}Ψ₁₋₂ [symbol] ) corresponds to the photon having taken the second interferometer arm 240-2 of the transmitter Alice (comprising the phase modulation α) then the second interferometer arm 340-2 of the receiver Bob (comprising the phase modulation β_{eff}). In this case, the interferometric delay is 2×Δt. Although the phase of the photon is equal to α+β_{eff} the probability of detecting the photon is then proportional to the squared modulus of the electric field and is therefore not affected by the two phase-modulation parameters α and β_{eff},
the third temporal mode (corresponding to a state |Ψ_{A-1}Ψ₁₋₂ [symbol] ) corresponds to the photon having taken the second interferometer arm 240-2 of the transmitter Alice (comprising the phase modulation α) then the first interferometer arm 340-1 of the receiver Bob. In this case, the interferometric delay of the photon is Δt and the photon acquires a phase α and undergoes phase fluctuations inducing a phase shift φ_{A} in particular associated with the interferometer arm 240-2 of the encoding interferometric module 200; and
the fourth temporal mode (corresponding to a state |Ψ_{A-2}Ψ₁₋₁ [symbol] ) corresponds to the photon having taken the first interferometer arm 240-1 of the transmitter Alice then the second interferometer arm 340-2 of the receiver Bob (comprising the phase modulation β_{eff}). In this case, the interferometric delay of the photon is Δt and the photon acquires a phase β_{eff} and undergoes phase fluctuations inducing a phase shift φ_{B} associated with the interferometer arm 340-2 of the transcoding interferometric module 300.

In particular, only photons having the same interferometric delay, i.e. t=Δt, are able to interfere with one another. Consequently, the result of this interference corresponds to a probability of detection by the unit 4222 (or 4422) of photons received with a delay Δt (i.e. the third and fourth temporal modes). The “probabilities of detection” P₊ and P₋ may be defined by the following equation, equation (16):

$${P}_{\pm } ( α , {β}_{eff} ) = \frac{1 \pm cos ( α - {β}_{eff} + {φ}_{A} - {φ}_{B} )}{2} \qquad ( 16 )$$

It will be noted that the + or − sign is assigned to the probability of detection P₊ or P₋ arbitrarily (via configuration) in the beam splitter 340 then set depending on the path of the photon on one of the two optical paths 340-3 or 340-4, then 422-1 or 442-1.

The processing module 400 may further comprise a unit 460 for storing values of the probabilities of detection P_{±}.

The system 1 for establishing quantum encryption keys may further comprise a display device (not shown in the figures) configured to generate a display of the stored probabilities on a human-machine interface.

Each processing portion 420 (440, respectively) may further comprise an auxiliary detector 4226 (4426, respectively) positioned on the other measurement arm, i.e. the reference measurement arm 422-2 (442-2, respectively). The auxiliary detector 4226 (4426, respectively) may be configured to detect conventional (i.e. non-quantum) light-pulse signals. For example and non-limitingly, the auxiliary detector 4226 (4426, respectively) may be a photodiode configured to deliver a photo-current, depending on the measurement of the phase-modulated interferometric reference signal S_{cB}.

Each auxiliary detector 4226 and 4426 may be configured to take a measurement called the “interferometric measurement” of the phase-modulated interferometric reference signal S_{cB}. In other words, each auxiliary detector 4226 and 4426 is able to measure the result of interference between the various possible interferometer arms of the reference signal passing through the interferometric modules 200 and 300.

Each measurement arm 422-1 and 422-2, 442-1 and 442-2 of the processing module 400 may further comprise an electronic filtering unit (denoted 4224, 4228, 4424 and 4428, respectively) and positioned after the single-photon detector or after the auxiliary detector. These filtering units may be configured to generate rectangular signals and be configured to extract the central temporal components equivalent to the interferometric delay Δt from the probabilities of detection (i.e. measured voltages) or from the photo-currents measured by the detectors 4222, 4226, 4422 and 4426.

In certain embodiments, the auxiliary detector 4226 (4426, respectively) and the single-photon detector 4222 (4422, respectively) of the processing portion 420 (440, respectively) may each comprise a frequency filter (not shown in the figures) associated with the frequencies ω_{c} and ω_{q}, respectively, so as to optimize detection of the equivalent signals (i.e. reference signal and quantum signal).

As indicated by equation (18) defining the probabilities of detection P_{±}, the quality of the contrast of the interference of single photons may be affected by the phase fluctuations inducing the phase shifts φ_{A} and φ_{B} associated with the interferometric modules 200 and 300, scrambling the quantum signal to be measured. Specifically, these parameters lead to far less marked probabilities of detection between the two single-photon detectors 4222 and 4422, which may be corrected for via the phase modulation β_{eff} in order to derive probabilities of detection according to equation (17):

$${P}_{\pm } ( α , β ) = \frac{1 \pm cos ( α - β )}{2} \qquad ( 17 )$$

The system 1 for establishing quantum encryption keys according to the embodiments of the invention may thus be configured to correct for the undesired phase fluctuations inducing the phase shifts φ_{A} and φ_{B} by applying a phase modulation β_{eff} determined by feedback to the quantum signal, on the basis of measurements of the reference signal. In one embodiment, the processing module 400 may further comprise a correcting unit 480 configured to determine a differential correction of the phase fluctuations between the phase shifts φ_{A} and φ_{B} of the interferometric modules 200 and 300, without compromising the security of the established secret key.

The auxiliary detectors of the processing portions 420 and 440 are advantageously configured to measure the result of interference between the various possible interferometer arms of the reference signal passing through the interferometric modules 200 and 300, the phase-modulated interferometric reference signal S_{cB} comprising three light pulses of various intensities, separated in time by the amount Δt. Only the central temporal component Δt is filtered by the filtering units 4228 and 4428, which deliver, to the correcting unit 480, two photo-currents (denoted for example I₄₂₀ and I₄₄₀) measured during each of the interferometric measurements of the reference signal tracing the two optical paths 340-3 and 340-4 at the output of the interferometric module 300 of the receiver Bob.

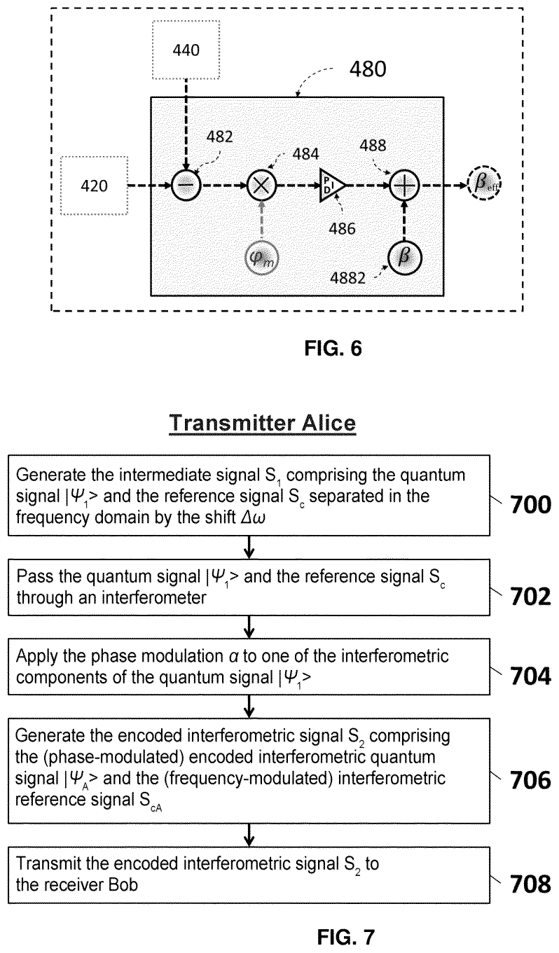

FIG. 6 schematically shows the correcting unit 480 of the processing module 400, according to embodiments of the invention.

The correcting unit 480 may be an electronic module.

In embodiments, the correcting unit 480 may comprise a subtracting means 482 configured to subtract δ=|I₄₂₀−I₄₄₀| the two photo-currents I₄₂₀ and I₄₄₀, this delivering an electronic signal δ proportional to the term cos (φ_{A}−φ_{B}−φₘ).

The correcting unit 480 may further comprise multiplying means 484 configured to multiply δₘ=δ*φₘ the electronic signal δ and the sinusoidal modulation signal φₘ, which depends on the control unit 3448 of the interferometric module 300 of the receiver Bob. The correcting unit 480 may comprise a low-pass filter 486 with a cut-off frequency lower than ωₘ, configured to determine an electronic signal ε, called the discrete error signal, from the product δₘ. The discrete error signal ε is then independent of the phase modulation φₘ and may be defined by the following equation, equation (18):

$$ε ∝ - {J}_{1} ( Δφ ) \times sin ( {φ}_{A} - {φ}_{B} ) \qquad ( 18 )$$

In equation (20) of the discrete error signal ε, the component J₁ corresponds to a Bessel function of order 1. The discrete error signal ε may thus correspond to the “differential correction ε of the phase fluctuations between the phase shifts φ_{A} and φ_{B}”.

The correcting unit 480 may lastly comprise an adder 488 configured to add the discrete error signal ε and a phase modulation β defined by a control unit 4882, this delivering the modulation β_{eff} that allows the phase shifts φ_{A} and φ_{B} to be canceled out (in an analog way or digitally).

Advantageously, the parameter β may be obtained in a similar manner to the parameter α defined by a control unit 2444. For example, the parameter β may for example be chosen from a set of two orthogonal bases such as [0, π] and [π/2, 3π/2] depending on a quantum random number generator.

The coincidences measured on the single-photon detectors and the probabilities P_{±} defined by equation (17) are thus uniquely given by α and β. Advantageously, according to embodiments of the invention, the correcting unit 480 feeds back the modulation β_{eff} using electronic elements that make it possible to achieve faster and continuous electronic compensation (or feedback), unlike in the prior art.

FIG. 7 is a flowchart showing the method for establishing quantum encryption keys implemented by the transmitter Alice (i.e. the method for transmitting an encoded interferometric signal S₂), according to embodiments of the invention.

In step 700, an intermediate signal S₁ is generated by the module 100 of the transmitter Alice. The intermediate signal S₁ comprises an intermediate quantum signal S_{q} (denoted |Ψ₁ [symbol] ) and a frequency-modulated intermediate reference signal S_{c}, having a frequency shift Δω with respect to the quantum signal |Ψ₁ [symbol] .

In step 702, the intermediate quantum signal |Ψ₁ [symbol] and the intermediate reference signal S_{c} pass through an interferometer (having two interferometer arms) of the encoding interferometric module 200 of the transmitter Alice. Consequently, the signal |Ψ₁ [symbol] and the signal S_{c} each split into two interferometric components that then pass through one of the two interferometer arms of the encoding interferometric module 200.

In step 704, the phase modulation α is applied by the encoding interferometric module 200 of the transmitter Alice to one of the two interferometric components of the quantum signal |Ψ₁ [symbol] in the interferometer.

In step 706, an encoded interferometric signal S₂ is generated at the output of the interferometer by the encoding interferometric module 200 of the transmitter Alice. The encoded interferometric signal S₂ comprises the phase-modulated encoded interferometric quantum signal |Ψ_{A} [symbol] , and the (frequency-modulated) interferometric reference signal S_{cA}.

In step 708, the encoded interferometric signal S₂ is then transmitted by the transmitter Alice to the receiver Bob.

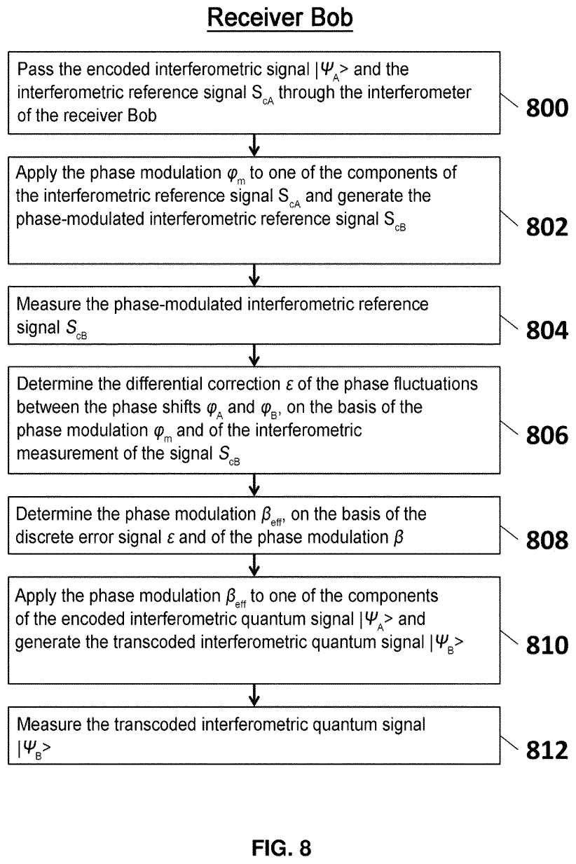

FIG. 8 is a flowchart showing the method for establishing quantum encryption keys implemented by the receiver Bob (i.e. the method for receiving an encoded interferometric signal S₂), according to embodiments of the invention.

In step 800, the encoded interferometric quantum signal |Ψ_{A} [symbol] and the interferometric reference signal S_{cA} pass through an interferometer (having two interferometer arms) of the transcoding interferometric module 300 of the receiver Bob. The signal |Ψ_{A} [symbol] and the signal S_{cA} thus each split into two interferometric components that then pass through one of the two interferometer arms of the transcoding interferometric module 300.

In step 802, the phase modulation φₘ is applied by the transcoding interferometric module 300 of the receiver Bob to one of the two components of the interferometric reference signal S_{cA}, this delivering the phase-modulated interferometric reference signal S_{cB} at the output of the interferometric module 300.

In step 804, at least one interferometric measurement of the phase-modulated interferometric reference signal S_{cB} is taken by the processing module 400 of the receiver Bob.

In step 806, an operation of determining the discrete error signal ε allowing differential correction of the phase fluctuations between the phase shifts φ_{A} and φ_{B} of the interferometric modules 200 and 300 is carried out, on the basis of the phase modulation φₘ and of the interferometric measurement of the phase-modulated interferometric reference signal S_{cB}.

In step 808, an operation of determining the phase modulation β_{eff} (taking into account the differential correction of the phase fluctuations between the phase shifts φ_{A} and φ_{B}) is carried out on the basis of the discrete error signal ε and of a phase modulation β.

In step 810, the phase modulation β_{eff} is applied by the transcoding interferometric module 300 of the receiver Bob to one of the two components of the encoded interferometric quantum signal |Ψ_{A} [symbol] , this delivering the transcoded interferometric quantum signal |Ψ_{B} [symbol] (i.e. delivering the projection of the signal |Ψ_{A} [symbol] onto the transcoded quantum states |Ψ_{B+} [symbol] and |Ψ_{B-} [symbol] ), at the output of the interferometric module 300.

In step 812, at least one interferometric measurement of the transcoded interferometric quantum signal |Ψ_{B} [symbol] (i.e. interferometric measurement of the projection of the encoded interferometric quantum signal |Ψ_{A} [symbol] onto the states |Ψ_{B+} [symbol] and |Ψ_{B-} [symbol] ) is taken by the processing module 400 of the receiver Bob, at the output of the interferometric module 300, with a view to deducing the quantum key therefrom.

The method for establishing quantum encryption keys may further comprise, in step 700, a sub-step 701 in which a time delay is applied to the intermediate quantum signal S_{q} to delay it with respect to the intermediate reference signal S_{c} so as to generate the intermediate signal S₁.

The embodiments of the invention thus make it possible to measure and compensate for in real time phase shifts φ_{A} and φ_{B} induced by the interferometric modules 200 and 300, and consequently make it possible to increase the signal-to-noise ratio of the generated and encoded quantum component. This results in a maximum capability in terms of modulation speed. Furthermore, the system 1 for establishing quantum encryption keys has the advantage of being unaffected by fluctuations in the intensity of the transmitted laser pulses, in particular as regards the reference signal.

Those skilled in the art will understand that system 1 for establishing quantum encryption keys or sub-systems of the system 1 for establishing quantum encryption keys, according to the embodiments of the invention, may be implemented in various ways by hardware, software, or a combination of hardware and software, and in particular in the form of program code that may be distributed as a program product, in various forms. The program code may be distributed using computer-readable media, which may include computer-readable storage media and communication media. The methods described in the present description may be implemented notably in the form of computer program instructions able to be executed by one or more processors in a computer-based computing device. These computer program instructions may also be stored in a computer-readable medium.

The invention is not limited to the embodiments described above by way of non-limiting example. It encompasses any variant of embodiment envisionable by those skilled in the art. In particular, those skilled in the art will readily understand that the invention is not limited to the various modules of the transmitter Alice and receiver Bob which were given by way of non-limiting example.

1. A transmitter configured to transmit an encoded interferometric signal S₂ through a transmission channel, said transmitter comprising:
a signal-generating module configured to generate an intermediate quantum signal |Ψ₁ [symbol] and an intermediate reference signal S_{c}, said signal-generating module further being configured to generate a frequency shift Δω between the intermediate quantum signal |Ψ₁ [symbol] and the intermediate reference signal S_{c}, and
an encoding interferometric module configured to receive said intermediate quantum signal |Ψ₁ [symbol] and said intermediate reference signal S_{c}, and to determine an encoded interferometric signal S₂ comprising an encoded interferometric quantum signal |Ψ_{A} [symbol] and an interferometric reference signal S_{cA} on the basis of said intermediate quantum signal |Ψ₁ [symbol] and of said intermediate reference signal S_{c} tracing a substantially similar optical path, the encoding interferometric module comprising an encoding device configured to apply a phase modulation α to only one component of the intermediate quantum signal |Ψ₁ [symbol] .

2. The transmitter as claimed in claim 1, wherein the encoding interferometric module takes the form of an asymmetric optical interferometer comprising a first interferometer arm and a second interferometer arm, the first interferometer arm being shorter than the second interferometer arm, and wherein said encoding device comprises at least one frequency-splitting unit positioned on said second interferometer arm, said frequency-splitting unit being configured to decouple, in the frequency domain, the intermediate quantum signal |Ψ₁ [symbol] and the intermediate reference signal S_{c}.

3. The transmitter as claimed in claim 1, the signal-generating module further comprising a time-shifting unit configured to shift, in the time domain, the intermediate quantum signal |Ψ₁ [symbol] with respect to the intermediate reference signal S_{c}.

4. A receiver configured to receive an encoded interferometric quantum signal |Ψ_{A} [symbol] and an interferometric reference signal S_{cA} through a transmission channel, said receiver comprising:
a transcoding interferometric module configured to generate a transcoded interferometric quantum signal |Ψ_{B} [symbol] and a phase-modulated interferometric reference signal S_{cB} on the basis of said encoded interferometric quantum signal |Ψ_{A} [symbol] and of said interferometric reference signal S_{cA} tracing a substantially similar optical path, said transcoding interferometric module comprising a transcoding and phase-modulating device that is configured to apply a phase modulation β_{eff} to only one component of the encoded interferometric quantum signal |Ψ_{A} [symbol] and a phase modulation φₘ to only one component of the interferometric reference signal S_{cA}, and
a processing module configured to take at least one measurement of the transcoded interferometric quantum signal |Ψ_{B} [symbol] and at least one measurement of the phase-modulated interferometric reference signal S_{cB}, said processing module further being configured to determine the phase modulation β_{eff} on the basis of the phase modulation φₘ and of said at least one measurement of the phase-modulated interferometric reference signal S_{cB}.

5. The receiver as claimed in claim 4, wherein the transcoding interferometric module takes the form of an asymmetric optical interferometer comprising a first interferometer arm and a second interferometer arm, the first interferometer arm being shorter than the second interferometer arm, and wherein said transcoding and phase-modulating device comprises at least one frequency-splitting unit positioned on said second interferometer arm, said frequency-splitting unit being configured to decouple, in the frequency domain, the encoded interferometric quantum signal |Ψ_{A} [symbol] and the interferometric reference signal S_{cA}.

6. The receiver as claimed in claim 4, the transcoding interferometric module comprising two optical paths at the output of said interferometer, and wherein the processing module comprises two processing portions, each processing portion comprising, each, one frequency-splitting unit and being configured to take one measurement among said at least one measurement of the transcoded interferometric quantum signal |Ψ_{B} [symbol] and one measurement among said at least one measurement of the phase-modulated interferometric reference signal S_{cB}, originating from the two optical paths.

7. A system for establishing a quantum encryption key, said system comprising a transmitter configured to transmit an encoded interferometric signal S₂ through a transmission channel, said transmitter comprising:
a signal-generating module configured to generate an intermediate quantum signal |Ψ₁ [symbol] and an intermediate reference signal S_{c}, said signal-generating module further being configured to generate a frequency shift Δω between the intermediate quantum signal |Ψ₁ [symbol] and the intermediate reference signal S_{c}, and
an encoding interferometric module configured to receive said intermediate quantum signal |Ψ₁ [symbol] and said intermediate reference signal S_{c}, and to determine an encoded interferometric signal S₂ comprising an encoded interferometric quantum signal |Ψ_{A} [symbol] and an interferometric reference signal S_{cA} on the basis of said intermediate quantum signal |Ψ₁ [symbol] and of said intermediate reference signal Se tracing a substantially similar optical path, the encoding interferometric module comprising an encoding device configured to apply a phase modulation α to only one component of the intermediate quantum signal |Ψ₁ [symbol] ,
the system further comprising a receiver as claimed in claim 4.

8. A method for transmitting an encoded interferometric signal S₂, said method being implemented by the transmitter as claimed in claim 1, the method comprising the steps of:
generating an intermediate quantum signal |Ψ₁ [symbol] of frequency ω_{q} and an intermediate reference signal S_{c} of frequency ω_{c} having a frequency shift equal to ω_{q}−ω_{c}
applying a phase modulation α to only one component of the intermediate quantum signal |Ψ₁ [symbol] passing through an interferometer, said intermediate quantum signal |Ψ₁ [symbol] and said intermediate reference signal S_{c} tracing a substantially similar optical path so as to generate an encoded interferometric signal S₂ comprising an encoded interferometric quantum signal |Ψ_{A} [symbol] and an interferometric reference signal S_{cA}, and
generating an encoded interferometric signal S₂ comprising said encoded interferometric quantum signal |Ψ_{A} [symbol] and said interferometric reference signal S_{cA}.

9. A method for transmitting an encoded interferometric signal S₂, as claimed in claim 8, wherein the method further comprises a step of applying a time delay between said intermediate quantum signal |Ψ₁ [symbol] and said intermediate reference signal S_{c}.

10. A method for receiving an encoded interferometric quantum signal |Ψ_{A} [symbol] and an interferometric reference signal S_{cA}, implemented by the receiver as claimed in claim 4, the method comprising the steps of:
applying a phase modulation φₘ to the component of the interferometric reference signal S_{cA} and generating a phase-modulated interferometric reference signal S_{cB},
taking at least one measurement of the phase-modulated interferometric reference signal S_{cB},
determining a phase modulation β_{eff} on the basis of said phase modulation φₘ and of the measurement of the phase-modulated interferometric reference signal S_{cB},
applying the phase modulation β_{eff} to the component of the encoded interferometric quantum signal |Ψ_{A} [symbol] and generating a transcoded interferometric quantum signal |Ψ_{B} [symbol] , said encoded interferometric quantum signal |Ψ_{A} [symbol] and said interferometric reference signal S_{cA} tracing a substantially similar optical path, and
taking at least one measurement of the transcoded interferometric quantum signal |Ψ_{B} [symbol] .
